(19) United States
(12) Patent Application Publication
(10) Pub. No.: US 2026/0169179 A1
(43) Pub. Date: Jun. 18, 2026

(54) NON-POWERED EARTHQUAKE DETECTION ACTUATOR

(71) Applicant: QSF inc., Seoul (KR)

(72) Inventors: Min Soo KIM, Seoul (KR); Chang Ho CHEON, Seoul (KR); Byeong Jin KIM, Seoul (KR); Do Hyun LEE, Seoul (KR)

(21) Appl. No.: 19/246,460

(22) Filed: Jun. 23, 2025

(30) Foreign Application Priority Data
Dec. 12, 2024 (KR) 10-2024-0184282

(51) Int. Cl. G01V 1/01

(52) U.S. Cl. CPC G01V 1/01

(57) ABSTRACT

The present disclosure relates to a non-powered earthquake detection actuator having an improved structure to detect an earthquake even by a mechanical structure design without an electronic circuit configuration.

### CROSS-REFERENCE TO RELATED APPLICATION(S

This application claims priority to Korea Patent Application No. 10-2024-0184282, filed December 12, 2024, the contents of which is incorporated by reference in its entirety.

### TECHNICAL FIELD

The present invention relates to a non-powered earthquake detection actuator and, more specifically, to a non-powered earthquake detection actuator with an improved structure capable of detecting an earthquake even by a mechanical structure design without an electronic circuit configuration.

### BACKGROUND ART

In general, a device for detecting an earthquake includes a sensor device composed of electrical circuit components and a calculation device for calculating data transmitted from the sensor device based on a control command of the control device.

Such an electronic earthquake detection device has a disadvantage in that a power source for driving the control device, the sensor device, and the like is separately required, thereby causing an increase in manufacturing costs due to a complex circuit design, being limited by an installation place, and hindering post-management efficiency due to frequent failures after installation.

### DISCLOSURE

### TECHNICAL PROBLEM

Accordingly, the present invention has been made in view of the above problems, and an object of the present invention is to provide a non-powered earthquake detection actuator capable of detecting earthquakes even by a mechanical structure design without an electronic circuit configuration, thereby achieving ease of product design and simplification of structure, being installed in various places and industrial sites without any limitations of installation environment, and increasing post-management efficiency.

### TECHNICAL SOLUTION

To achieve the purpose, the non-powered earthquake detection actuator according to the present invention comprises: a case having an installation space in which components can be installed; an earthquake detection unit provided in the installation space of the case to detect an earthquake; and an actuating unit connected to both elements between the earthquake detection unit and a load body, and enabling the operation of the load body such as opening and closing a valve, wherein the earthquake detection unit comprises an earthquake detection moving member installed in an installation space of the case to move up and down between a normal first position before an earthquake occurs and a second position after the earthquake occurs, and the earthquake detection moving member comprises: a frame part which defines an empty inner space and to which an elastic force is applied in a downward direction by connecting a spring, and a locking part which protrudes outward from one side of the frame part and selectively locks the position of the frame part by an engagement action with a counterpart; a support which is fixed and installed at a position vertically dividing the installation space of the case into two parts without interference with the earthquake detection moving member, and of which a vertical distance from an upper acting surface of the frame part gradually decreases from the center toward the edge; and a spherical ball which is disposed at the center of the support, is formed in a spherical shape, moves in an eccentric direction from the center of the support according to vibration occurrence, and moves the earthquake detection moving member upward by pressing the upper acting surface of the frame part when moving in the eccentric direction of the support by vibration occurrence while being disposed at the center of the support; and thus, the earthquake detection moving member selectively moves up and down according to the relative movement of the spherical ball with respect to the support, and the locking state between the locking part and the actuating unit is released during the upward movement, thereby inducing the operation of the actuating unit.

The earthquake detection moving member may include a pair of guide protrusions protruding upward from an upper end working surface of the frame portion, and the case may include guide groove portions formed at positions facing the pair of guide protrusions.

The earthquake detection moving member may include a reset protrusion protruding downward from the center of the lower end of the frame portion and exposed to the outside of the case, and the case may include a reset through-hole formed at a position facing the reset protrusion.

The actuating unit may include: a disk-shaped rotating member which is installed in an installation space of the case so as to be relatively rotatable, has a stepped lug for interacting with a locking part of the earthquake detection moving member, has an receiving groove in which the locking part is accommodated between the stepped lug and a circumferential line, and has an actuating protrusion provided at a position eccentric from the center; and a load body-driving moving member which is installed in the installation space of the case so as to be vertically movable at a position which does not interfere with the earthquake detection moving member, has a connection slit into which the actuating protrusion is inserted, and is formed in a size such that the connection slit allows the protrusion to rotate, and one side of a load body-driving moving member is mechanically connected to the load body so as to apply mechanical force according to the moving operation to the load body.

The present invention includes a spring having one side connected to the case and the other side connected to the load body-driving moving member, and is configured to maintain the locked state by applying the elastic force of the spring to the circular rotating member through the load body-driving moving member in a locked state (a state in which a locking part is caught by a locking protrusion) between the moving member for detecting an earthquake and the circular rotating member, and to operate the load body through the load body-driving moving member by applying the elastic force of the spring to the load body-driving moving member when the locked state is released according to the moving operation of the moving member for detecting an earthquake.

The case may include a guide slit formed to be elongated in the vertical direction, and the load body-driving moving member may further include a protrusion for connecting the load body that is lifted and lowered along the guide slit while being inserted into the guide slit.

### Advantageous Effects

A non-powered earthquake detection actuator according to the present invention is configured to maintain a state in which a spherical ball placed on a support does not move and is placed at the center of the support in a normal situation where an earthquake does not occur so as to not change the displacement of a support detection moving member (receiving force downward due to elastic force from a spring), thereby maintaining a locking state between a locking part of the support detection moving member and an actuating unit to perform a first function of the actuating unit according to a preset design specification (for example, maintaining fluid flow by maintaining the opening of a valve), and on the contrary, when an earthquake occurs by a vibration having a predetermined magnitude, the spherical ball pressurizes an upper acting surface of a frame part of the support detection moving member to cause the upward movement of the frame part, and to perform a second function of the actuating unit (for example, blocking fluid flow by closing the valve) as the locking state between the locking part and the actuating unit is released according to the upward movement of the frame part.

Consequently, the present invention having such a configuration can detect earthquakes even by a mechanical structural design without an electronic circuit configuration, thereby achieving ease of product design and simplification of the structure, can be installed in various places and industrial sites without any limitations on the installation environment, and can increase post-management efficiency.

### BRIEF DESCRIPTION OF DRAWINGS

FIG. 1 is a perspective view of a non-powered earthquake detection actuator according to an embodiment of the present invention.

FIG. 2 is an exploded perspective view of an embodiment of the present invention.

FIG. 3 is a rear side separation perspective view of an embodiment of the present invention.

FIG. 4 is a rear view in a state in which the rear case employed in the embodiment of the present invention is removed.

FIGS. 5 and 6 are diagrams for explaining an operation process of an embodiment of the present invention.

### BEST MODE

The following embodiments are detailed descriptions for helping understanding of the present invention, and it will be natural that the scope of the present invention is not limited. Accordingly, an equal invention that performs the same function as the present invention will also fall within the scope of the present invention.

In the following description, the same identification symbols mean the same configuration, and unnecessary redundant descriptions and descriptions of known technologies will be omitted. In addition, the description of each embodiment of the present invention overlapping the description of the technology that is the background of the present invention will also be omitted.

Hereinafter, a non-powered earthquake detection actuator according to an embodiment of the present invention will be described in detail with reference to the accompanying drawings.

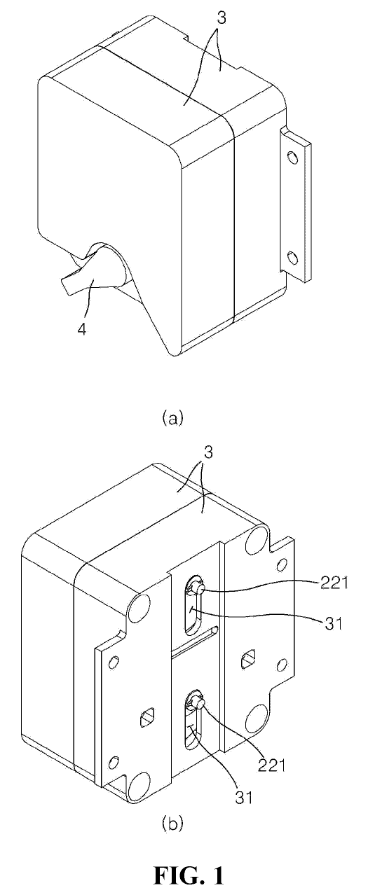

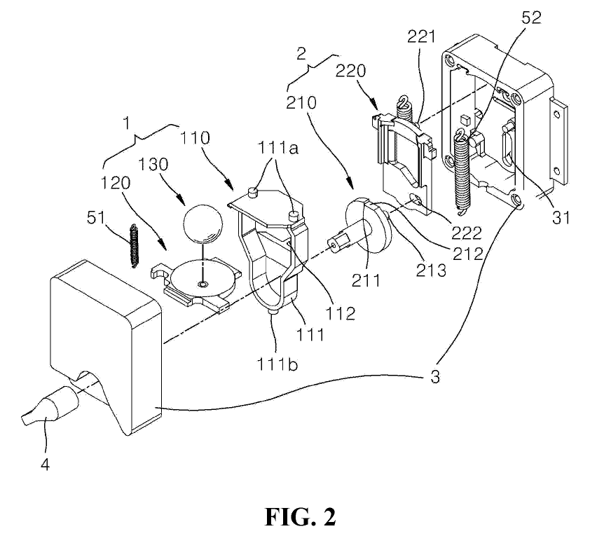

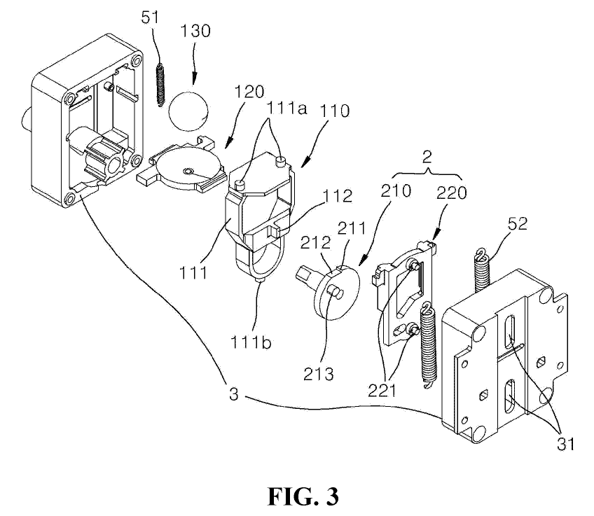

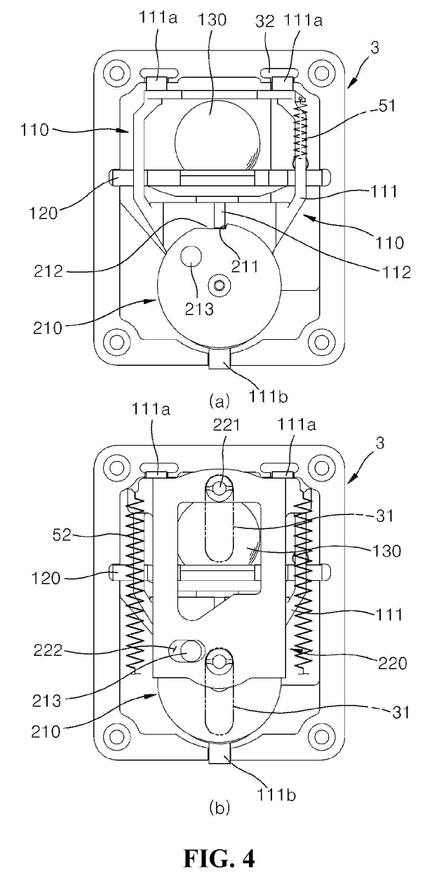

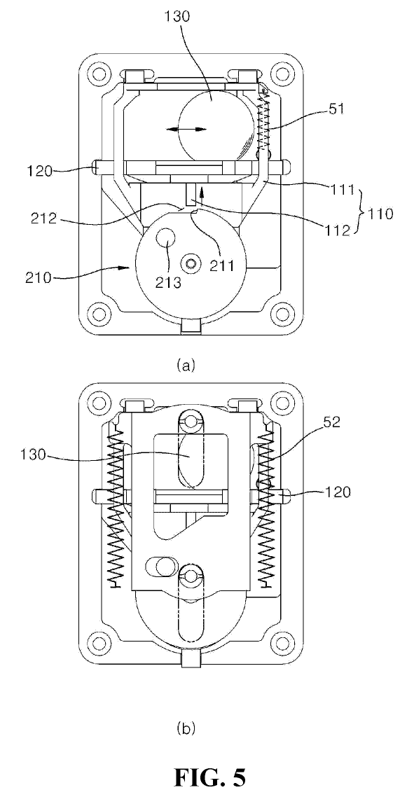

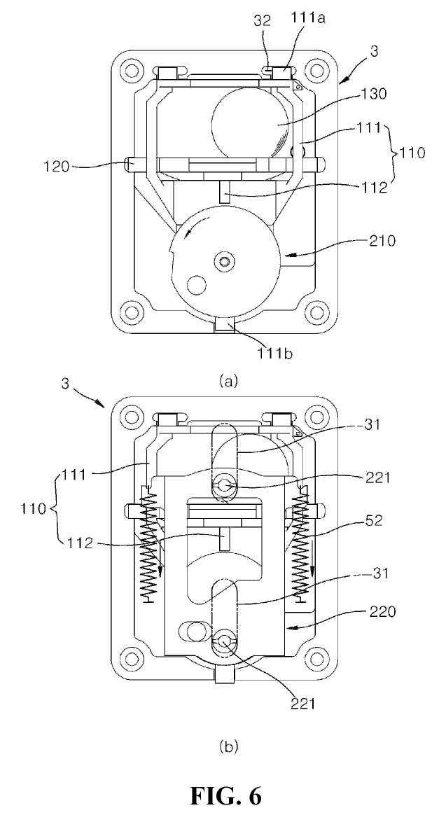

FIG. 1 is a perspective view of a non-powered earthquake detection actuator according to an embodiment of the present invention, FIG. 2 is an exploded perspective view of an embodiment of the present invention, FIG. 3 is a rear exploded perspective view of an embodiment of the present invention, FIG. 4 is a rear view in a state in which a rear case employed in an embodiment of the present invention is removed, and FIGS. 5 and 6 are diagrams for explaining an operation process of an embodiment of the present invention.

As shown in FIGS. 1 to 3, the non-powered earthquake detection actuator according to an embodiment of the present invention may detect an earthquake even by a mechanical structure design without an electronic circuit configuration, and includes a case 3, an earthquake detection unit 1, and an actuating unit 2.

The case 3 provides an installation space in which components may be installed, and serves to protect the components accommodated in the installation space from the outside.

The earthquake detection unit 1 is provided in the installation space of the case 3 to detect an earthquake, and the actuating unit 2 is mechanically connected to the earthquake detection unit 1 and a load body(not shown), thereby enabling the operation of the load body such as opening and closing a valve.

The earthquake detection unit 1 is implemented entirely through a mechanical structure design without electronic circuit components, and includes an earthquake detection moving member 110, a support 120, and a spherical ball 130.

As shown in FIGS. 4 to 6, the earthquake detection moving member 110 includes a frame part 111 installed movably in the installation space of the case 3, and a locking part 112 integrally formed with the frame part 111 and protruding outward from one side of the frame part 111.

The frame part 111 is vertically moved between a first position (see FIG. 4) corresponding to an initial position before an earthquake and a second position (see FIG. 6) after an earthquake, is formed in a frame structure in which an inner side is empty, has an inner space in which a component may be disposed, and receives a downward elastic force by being connected to a spring 51.

That is, when there is no external vibration, the frame part 111 always maintains the first position due to the elastic force by the spring 51 as shown in FIG. 4, and moves to the second position due to the force overcoming the elastic force only when the vibration having an acceleration greater than the elastic force is generated as shown in FIG. 6.

The locking part 112 protrudes outward from one side of the frame part 111 to perform a catching action with the counterpart, and serves to selectively lock the position of the frame part 111.

As shown in FIGS. 3 and 4, the support 120 is fixedly installed at a position where the installation space of the case 3 is divided into two up and down without interference with the support detection moving member, and is configured such that the vertical distance from the upper end action surface of the frame part 111 gradually decreases from the center to the edge so as to cause a height change according to the movement when the spherical ball 130 is moved in the state in which it is placed.

That is, if the contact surface of the support 120 with the spherical ball 130 is formed in a flat structure unlike the present embodiment, only the horizontal movement of the spherical ball 130 may be expected, and the spherical ball 130 may not press the upper end action surface of the frame part 111 regardless of whether vibration is generated, and thus vibration may not be detected at all.

In the present embodiment, in order to overcome this disadvantage, the contact surface of the support 120 with the spherical ball 130 is formed in a curved shape, and the vertical distance from the upper end action surface of the frame part 111 is gradually reduced from the center to the edge, so that the spherical ball 130 may smoothly press the upper end action surface of the frame part 111 when vibration is generated.

The spherical ball 130 is disposed at the center of the support body 120 and has a spherical shape, and as shown in FIGS. 4 to 6, moves in an eccentric direction from the center of the support body 120 according to vibration generation, and when the spherical ball 130 is moved in the eccentric direction by vibration generation in the state of being disposed at the center of the support body 120 due to vibration generation while being positioned at the center of the support (120), the spherical ball 130 presses the upper working surface of the frame part (111), and as a result, the earthquake detection moving member (110) moves upward.

As described above, the spherical ball 130 moves in the eccentric direction from the center of the support 120 according to the generation of vibration, and when the force applied to the upper end action surface of the frame part 111 according to the movement is greater than the elastic force, the earthquake detection moving member 110 provided with the frame part 111 is moved upward.

Hereinafter, an operation process of an embodiment of the present invention will be described in detail with reference to FIGS. 4 to 6.

FIGS. 4 to 6(b) are rear views showing an operation in a state in which the rear case is removed among the cases 3 employed in the embodiment of the present invention, and FIGS. 4 to 6(a) are views showing a state in which the load body-driving moving member 220 is removed from FIG. 4(b) in order to describe a configuration and related operation involved in the catching operation between the locking unit 112 and the actuating unit 2.

When the earthquake detection moving member 110 is raised, as shown in FIG. 4A, the locking state between the locking part 112 and the actuating unit 2 is released, and the actuating unit 2 is operated to exhibit a function required according to preset design specifications.

For example, when the actuating unit 2 is designed to implement an opening/closing operation of a specific valve, as shown in FIG. 4, the valve is maintained in an open state in a state in which the locking unit 112 and the actuating unit 2 are interlocked, thereby enabling a flow of a fluid such as gas or liquid, and conversely, as shown in FIGS. 5 and 6, when vibration is generated and the interlocking state between the locking unit 112 and the actuating unit 2 is released, the valve is switched from the open state to the closed state, thereby blocking the flow of the fluid.

A non-powered earthquake detection actuator according to the present invention is configured to maintain a state in which a spherical ball placed on a support does not move and is placed at the center of the support in a normal situation where an earthquake does not occur so as to not change the displacement of a support detection moving member (receiving force downward due to elastic force from a spring), thereby maintaining a locking state between a locking part of the support detection moving member and an actuating unit to perform a first function of the actuating unit according to a preset design specification (for example, maintaining fluid flow by maintaining the opening of a valve), and on the contrary, when an earthquake occurs by a vibration having a predetermined magnitude, the spherical ball pressurizes an upper acting surface of a frame part of the support detection moving member to cause the upward movement of the frame part, and to perform a second function of the actuating unit (for example, blocking fluid flow by closing the valve) as the locking state between the locking part and the actuating unit is released according to the upward movement of the frame part.

On the contrary, when an earthquake occurs due to vibration of a predetermined magnitude, in this embodiment, the spherical ball 130 presses the upper end action surface of the frame part 111 of the moving member for support detection to cause the upward movement of the frame part 111, and as the locking part 112 and the actuating unit 2 are released from the locked state as shown in FIG. 5 according to the upward movement of the frame part 111, the second function (e.g., blocking of fluid flow according to closing of the valve) of the actuating unit 2 is performed.

Consequently, the present embodiment having such a configuration is advantageous in that an earthquake can be detected even by a mechanical structural design without an electronic circuit configuration, thereby making it possible to achieve ease of product design and simplification of the structure, that it can be installed in various places and industrial sites without any limitations in the installation environment, and that it can increase post-management efficiency.

The earthquake detection moving member 110 provided in the present embodiment includes a pair of guide protrusions 111a protruding upward from the upper end action surface of the frame part 111, and in response to this structure, the case 3 includes guide grooves 32 formed at positions facing the pair of guide protrusions 111a.

In the present embodiment having such a configuration, the up and down movement of the earthquake detection moving member 110 is precisely implemented by the interaction between the pair of guide protrusions and the guard groove parts, so that it is possible to remarkably prevent precise vibration detection from being hindered due to disturbance rather than actual vibration when the spherical ball 130 is moved.

In addition, the earthquake detection moving member 110 may include b reset protrusion 111a protruding downward from the center of the lower end of the frame part 111 and exposed to the outside of the case 3, and in response thereto, the case 3 may include b reset through hole formed at a position facing the reset protrusion 111a.

In the present embodiment having such a configuration, the user can reset the initial setting value of the operating unit 2 by pressing the reset protrusion 111b to release the interlocking state between the locking portion 112 of the earthquake detection moving member 110 and the actuating unit 2, thereby enabling the actuating unit 2 to perform various functions.

As shown in FIGS. 3 and 4, the actuating unit 2 employed in the present embodiment includes a disk-shaped rotation member 210 installed in the installation space of the case 3 to be relatively rotatable, and a load body-driving moving member 220 installed in the installation space of the case 3 to be vertically movable at a position that does not interfere with the earthquake detection moving member 110 and provided with a configuration that interacts with the disk-shaped rotation member 210.

The disk-shaped rotation member 210 includes a stepped lug 211, an accommodating groove 212, and an actuating protrusion 213. The stepped lug 211 is a component that interacts with the locking portion 112 of the earthquake detection moving member 110, the accommodating groove 212 is a component that forms a space in which the locking portion 112 is accommodated between the stepped lug211 and the circumferential line, and the actuating protrusion 213 is a component that is provided at a position eccentric from the center of the disk-shaped rotating member 210 and is connected to the load body-driving moving member 220.

The load body-driving moving member 220 is connected to the disk-shaped rotating member 210 in a power manner to perform a vertical lifting motion according to the rotational motion of the disk-shaped rotating member 210, wherein a connection slit 222 into which the actuating protrusion 213 is inserted is formed in a size to allow rotation of the protrusion, and one side is mechanically connected to the load body to apply power according to the moving motion to the load body.

In the present embodiment having such a configuration, when the earthquake detection moving member 110 is raised upward by vibration, as shown in FIG. 5, the locking state of the locking portion 112 caught by the stepped lug211 is released in a state of being accommodated in the accommodating groove 212 of the disk-shaped rotating member 210, and at the same time, the disk-shaped rotating member 210 is in a state of being free to rotate.

In this state, as shown in FIG. 6, when the disk-shaped rotation member 210 rotates, the actuating protrusion 213 of the disk-shaped rotation member 210 moves up and down the load body-driving moving member 220 while eccentrically rotating, and accordingly, the load body (e.g., a valve) connected to the load body-driving moving member 220 performs a function according to a preset design specification.

As a result, in the present embodiment, the operation and function of the actuating unit 2 may be implemented by mechanical connection between the disk-shaped rotary member 210 and the load body-driving moving member 220 without an electronic circuit component, so that the product structure may be simplified and the ease of design may be expected.

In the present embodiment, a spring 52 is provided as a power source for rotating the disk-shaped rotation member 210. That is, one side of the spring 52 is connected to the case 3 and the other side thereof is connected to the load body-driving moving member 220.

In the present embodiment having such a configuration, as shown in FIG. 4, in the locking state between the earthquake detection moving member 110 and the disk-shaped rotation member 210 (in the state in which the locking part 112 is caught by the stepped lug 211), the elastic force of the spring 52 is applied to the disk-shaped rotation member 210 through the load body driving moving member 220 to maintain the locking state, and as shown in FIGS. 5 and 6, when the locking state is released according to the moving operation of the earthquake detection moving member 110, the elastic force of the spring 52 is applied to the load body-driving moving member 220 to operate the load body through the load body driving moving member 220, such that the power device for driving the load body may be implemented by a simple configuration.

The case 3 employed in the present embodiment includes a guide slit 31 formed to be elongated in the vertical direction, and correspondingly, the load body-driving moving member 220 includes a load body connection protrusion 221 that is lifted and lowered in a state of being inserted into the guide slit 31. Here, since the load body connection protrusion is guided and lifted by the guide slit 31, it is possible to implement a precise operation of the load body-driving moving member 220 with respect to the case 3, and it is also possible to be mechanically connected to the load to perform a required function of the load body.

The present embodiment having such a configuration enables precise operation implementation without shaking during relative movement of the load body-driving moving member 220 with respect to the case 3.

In the drawings, reference numeral 4 is a rotation lever that is engaged with the rotation center axis of the disk-shaped rotation member 210 and rotates together.

Although various embodiments of the present disclosure have been described above, the present embodiment and the drawings attached to the present disclosure only clearly represent a part of the technical idea included in the present disclosure, and it will be obvious that all modified examples and specific embodiments that can be easily inferred by those skilled in the art within the scope of the technical idea included in the specification and drawings of the present disclosure are included in the scope of the rights of the present disclosure.

1. A non-powered earthquake detection actuator which is capable of detecting earthquakes even by mechanical structural design without electronic circuit configuration, comprising:
a case having an installation space in which components can be installed; an earthquake detection unit provided in the installation space of the case to detect an earthquake; and an actuating unit connected to both elements between the earthquake detection unit and a load body, and enabling the operation of the load body such as opening and closing a valve,
wherein the earthquake detection unit comprises:
an earthquake detection moving member installed in an installation space of the case to move up and down between a normal first position before an earthquake occurs and a second position after the earthquake occurs, and the earthquake detection moving member comprises: a frame part which defines an empty inner space and to which an elastic force is applied in a downward direction by connecting a spring, and a locking part which protrudes outward from one side of the frame part and selectively locks the position of the frame part by an engagement action with a counterpart;
a support which is fixed and installed at a position vertically dividing the installation space of the case into two parts without interference with the earthquake detection moving member, and of which a vertical distance from an upper acting surface of the frame part gradually decreases from the center toward the edge; and
a spherical ball which is disposed at the center of the support, is formed in a spherical shape, moves in an eccentric direction from the center of the support according to vibration occurrence, and moves the earthquake detection moving member upward by pressing the upper acting surface of the frame part when moving in the eccentric direction of the support by vibration occurrence while being disposed at the center of the support; and thus,
the earthquake detection moving member selectively moves up and down according to the relative movement of the spherical ball with respect to the support, and the locking state between the locking part and the actuating unit is released during the upward movement, thereby inducing the operation of the actuating unit.

2. The non-powered earthquake detection actuator of claim 1, wherein the earthquake detection moving member comprises a pair of guide protrusions protruding upward from an upper end working surface of the frame portion, and the case comprises guide groove portions formed at positions facing the pair of guide protrusions.

3. The non-powered earthquake detection actuator of claim 1, wherein the earthquake detection moving member comprises a reset protrusion protruding downward from the center of the lower end of the frame portion and exposed to the outside of the case, and the case comprises a reset through-hole formed at a position facing the reset protrusion.

4. The non-powered earthquake detection actuator of claim 1,
wherein the actuating unit comprises:
a disk-shaped rotation member installed in an installation space of the case so as to be relatively rotatable, having a stepped lug for interacting with a locking part of the earthquake detection moving member, having a receiving groove formed between the stepped lug and circumferential line and in which the locking part is received, and having an actuating protrusion provided at a position eccentric from a center thereof; and
a load body-driving moving member which is installed in the installation space of the case so as to be vertically movable at a position which does not interfere with the earthquake detection moving member, has a connection slit into which the actuating protrusion is inserted, and is formed in a size such that the connection slit allows the protrusion to rotate, and one side of a load body-driving moving member is mechanically connected to the load body so as to apply mechanical force according to the moving operation to the load body.

5. The non-powered earthquake detection actuator of claim 4,
further comprising a spring having one side connected to the case and the other side connected to the load body-driving moving member, such that,
in a state in which the earthquake detection moving member and the disk-shaped rotation member are locked (in a state in which the locking part is caught by the stepped lug), the elastic force of the spring is applied to the disk-shaped rotation member through the load body-driving moving member to maintain the locking state, and when the locking state is released according to the upward movement of the earthquake detection moving member, the elastic force of the spring is applied to the load body-driving moving member to operate the load body through the load body-driving moving member.

6. The non-powered earthquake detection actuator of claim 4, wherein the case comprises a guide slit extending in the vertical direction, and the load body-driving moving member further comprises a protrusion for connecting the load body, which is moved up and down along the guide slit while being inserted into the guide slit.
